(19) United States
(12) Patent Application Publication
(10) Pub. No.: US 2005/0038158 A1
(43) Pub. Date: Feb. 17, 2005

(54) Highly filled ethylene/vinyl ester copolymers

(76) Inventors: Stephen P. Musemeche, Orange, TX (US); George Wyatt Prejean, Orange, TX (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/874,867

(22) Filed: Jun. 23, 2004

Related U.S. Application Data
(60) Provisional application No. 60/495,662, filed on Aug. 15, 2003.

(51) Int. Cl. C08K 5/15; C08K 3/26

(52) U.S. Cl. 524/284; 524/425

(57) ABSTRACT

Disclosed are filled and plasticized blends of ethylene/vinyl ester copolymers modified with organic acids, consisting essentially of (a) from about 1 to about 15% by weight of at least one ethylene/vinyl ester copolymer; (b) from about 1 to 5 percent by weight of at least one plasticizer selected from the group consisting of processing oils, epoxidized oils, polyesters, polyethers, and polyether esters; (c) from about 80 to about 90% by weight of filler; (d) from about 0.05 to about 5% by weight of at least one organic acid or acid derivative selected from the group consisting of dimer and trimer acids having from 36 to 60 carbon atoms, and mixtures thereof; and optionally (e) from 0 to about 5% by weight of tackifier; wherein all weight percents are based on the total weight of components (a) through (e). Also disclosed are sound management sheets that comprise these compositions. Also disclosed are carpets, especially automotive carpets, having backside coatings comprising these compositions.

### CROSS-REFERENCE TO RELATED APPLICATIONS

Applicant claims the benefit of priority to provisional application 60/495,662 filed Aug. 15, 2003; herein incorporated by reference in its entirety.

### BACKGROUND OF THE INVENTION

1. Field of the Invention

The present invention relates to thermoplastic soundproofing compositions. More specifically, this invention relates to highly filled and plasticized blends of ethylene/vinyl ester copolymers modified with organic acids and their use in making sound-deadening sheets and automotive carpet backing.

2. Description of the Related Art

Certain ethylene copolymers combined with inorganic fillers and modified with, for example, organic acids have been used for sound management purposes such as sound barriers or sound deadening. In general, there are three ways in which sound can be minimized or managed. The sound waves can be blocked, the vibrations can be damped, or the noise can be absorbed. To manage sound in these various ways, articles with different characteristics are required.

U.S. Pat. No. 6,319,969 discloses compositions of ethylene and/or α-olefin/vinyl or vinylidene interpolymers, particularly ethylene/styrene interpolymers, an organic acid and filler.

U.S. Pat. No. 4,434,258 discloses filled thermoplastic compositions obtained by blending about 0-50% by weight of an ethylene interpolymer, such as (among others) ethylene/vinyl esters; 0 to 20% by weight of a plasticizer selected from the group consisting of processing oils, epoxidized oils, polyesters, polyethers, polyether esters and combinations thereof; about 40-90% by weight of filler; from about 0.05 to about 5.0% by weight of at least one organic acid or acid derivative selected from the group consisting of saturated polycarboxylic acids having from 6 to 54 carbon atoms, unsaturated mono- and dicarboxylic acids having from 12 to 20 carbon atoms, alicyclic and aromatic carboxylic acids, and mono-, di- and trivalent metal salts, esters and amides of said acids.

U.S. Pat. No. 4,430,468 discloses similar filled thermoplastic compositions obtained by blending about 0-50% by weight of an ethylene interpolymer, such as (among others) ethylene/vinyl esters; 0 to 20% by weight of a plasticizer selected from the group consisting of processing oils, epoxidized oils, polyesters, polyethers, polyether esters and combinations thereof; about 40-90% by weight of filler; from about 0.05 to about 5.0% by weight of at least one surface active agent such as sulfonates, sulfates, phosphates, and optionally modifying resins, such as tackifiers and certain ethylene and propylene homo- and copolymers.

These patents also describe the above compositions in the form of sound-deadening sheets and carpets having a backside coating of the above compositions.

### BRIEF SUMMARY OF THE INVENTION

It is desirable to improve the sound deadening qualities afforded by filled ethylene copolymers, such as those described above, by increased filler loadings while maintaining excellent physical properties such as elongation to break (greater than 300%) and ductile behavior (lack of brittleness.

Accordingly, this invention provides a filled thermoplastic composition consisting essentially of
from about 1 to about 15% by weight of at least one ethylene/vinyl ester copolymer;
(b) from about 1 to 5 percent by weight of at least one plasticizer selected from the group consisting of processing oils, epoxidized oils, polyesters, polyethers, and polyether esters;
(c) from about 80 to about 90% by weight of filler;
(d) from about 0.05 to about 5% by weight of at least one organic acid or acid derivative selected from the group consisting of dimer and trimer acids having from 36 to 60 carbon atoms, and mixtures thereof; and optionally
(e) from 0 to about 5% by weight of tackifier,
wherein all weight percents are based on the total weight of components (a) through (e).

When formed into sheets, the filled compositions according to the instant invention help stop vibration that causes noise. Accordingly, this invention also provides for sound management (i.e. sound deadening) sheets comprising these compositions. This invention further provides for carpets, especially automotive carpets, having backside coatings comprising the above compositions.

### DETAILED DESCRIPTION OF THE INVENTION

As used herein the term “consisting essentially of” means that the named ingredients are essential; however, other ingredients that do not prevent the advantages of the present invention from being realized can also be included.

All references disclosed herein are incorporated by reference.

“Copolymer” means polymers containing two or more different monomers. The terms “dipolymer” and “terpolymer” mean polymers containing only two and three different monomers respectively. The phrase “copolymer of various monomers” and the like means a copolymer whose units are derived from the various monomers.

As used herein, the number of carbon atoms in a chemical moiety is designated by the notation Cₙ, in which n represents the number of carbon atoms present in said moiety.

Thermoplastic Resins

Thermoplastic compositions are polymeric materials that can flow when heated under pressure. Melt index (MI) is the mass rate of flow of a polymer through a specified capillary under controlled conditions of temperature and pressure. Melt indices reported herein are determined according to ASTM 1238 at 190° C. using a 2160 g weight, with values of MI reported in grams/10 minutes.

The ethylene copolymers suitable for the composition of the present invention are copolymers with at least one comonomer selected from the group consisting of vinyl esters of saturated carboxylic acids wherein the acid moiety has up to 4 carbon atoms. Copolymers of ethylene and a vinyl ester include copolymers such as ethylene/vinyl acetate (abbreviated EVA), ethylene/vinyl propionate and ethylene/vinyl butanoate. Preferred copolymers are those wherein the vinyl ester is vinyl acetate (i.e. ethylene/vinyl acetate copolymers).

Melt index of the copolymer can range from about 0.1 to about 400, preferably from about 0.1 to about 50. Physical properties, principally elongation, decline to lower levels when the ethylene copolymer melt index is above about 50. Lower melt index ranges, from about 1 to about 10, are most preferred to maintain strength.

The ethylene content of the copolymer is from about 40 to about 95% by weight, and the comonomer content is from about 5 to about 60% by weight. The preferred ethylene and comonomer level is from about 45 to about 91% and from about 9 to about 55% by weight, respectively. The most preferred ethylene and comonomer content is from about 88 to about 72% and from about 12 to about 28%, respectively. A mixture of two or more ethylene copolymers can be used in the blends of the present invention in place of a single copolymer as long as the average values for the comonomer content will be within the range indicated above.

Employing a copolymer containing over 28% nonethylenic comonomer (such as vinyl acetate) results in blends that are less stiff and have lower tensile strength, while their elongation is increased. The most preferred level is from about 12 to about 28 weight percent. Below 12% vinyl acetate, the blends become much stiffer, lose elongation, and oil compatibility problems may arise. Even blends made with nonbleeding oils tend to become “oily” as polyethylene homopolymer is approached.

A mixture of two or more ethylene copolymers as described herein can be used in the blends of the present invention in place of a single copolymer as long as the average values for the comonomer content will be within the range indicated above. Particularly useful properties can be obtained when two properly selected ethylene copolymers are used in blends of the present invention. Of note is a composition of this invention wherein the ethylene/vinyl acetate copolymer (i.e. an example of component (a)) comprises two different ethylene/vinyl acetate (EVA) copolymers. By combining two different properly selected EVA copolymer grades with filler, plasticizer, and an organic acid, modification of the physical properties of the filled composition can be achieved as compared with compositions containing only a single EVA resin grade. Most significantly, by replacing a single EVA grade in a filled blend with an equal amount of a properly selected mixture of two EVA grades, where the mixture has the same weight percent vinyl acetate content and melt index as the single EVA grade replaced, the tensile elongation can be increased substantially.

Plasticizers

The first group of plasticizer ingredients useful in the composition of the present invention is known as process or processing oil. Three types of processing oils are known: paraffinic, aromatic and naphthenic. None of these are pure; the grades identify the major oil type present.

Paraffinic oils tend to “bleed” from blends. Bleeding is normally not desirable, but could be useful in specialty applications, for example, in concrete forms where mold release characteristics are valued.

On the other hand, naphthenic acid and aromatic oils are nonbleeding when used in proper ratios and are thus preferable for uses such as automotive carpet backside coatings.

Processing oils are also subdivided by viscosity range. “Thin” oils can be as low as 100-500 SUS (Saybolt Universal Seconds) at 100° F. (38° C.). “Heavy” oils can be as high as 6000 SUS at 100° F. (38° C.). Processing oils, especially naphthenic and aromatic oils with viscosity of from about 100 to 6000 SUS at 100° F. (38° C.) are preferred.

The amount of plasticizer, such as the processing oil, present in the composition of the present invention is from about 1 to about 5% by weight. Most preferably when using a filler of medium density, such as calcium carbonate, the amount of processing oil is from about 2 to about 5% by weight, and when using a filler of higher density, such as barium sulfate, the amount of processing oil is from about 1 to about 4% by weight.

In the selection of a processing oil, other factors such as the type of oil selected and its viscosity must be considered. These are discussed in detail in U.S. Pat. No. 4,191,798, incorporated herein by reference.

The second group of plasticizers that are useful in the practice of the present invention is the group comprising epoxidized oils such as epoxidized soybean oil and epoxidized linseed oil.

The third group of plasticizers that are useful are the polyesters, which, in general, are liquid condensation products of a polybasic acid and a polyol. The term “liquid” in the context of the present invention is used to mean pourable at room temperature. The acid component is most often a saturated aliphatic dibasic acid or an aromatic dibasic acid; adipic acid, azelaic acid, phthalic acid, sebacic acid, and glutaric acid, or mixtures thereof. The polyol can be an aliphatic polyol or a polyoxyalkylene polyol, such as ethylene glycol, propylene glycol, 1,4- and 1,3-butane glycol, diethylene glycol, and polyethylene glycol. Preferred polyester compositions would consist of an acid component of which greater than 50% by weight are aliphatic dibasic acids, and a polyol component of aliphatic polyol or even more preferably aliphatic glycol. Most preferred compositions are based on adipic or azelaic acid, and propylene glycol or 1,3- or 1,4-butane glycol. The molecular weight of these plasticizers can vary from a low of a few hundred up to a high of about 10,000. The molecular weight of commercial products is seldom specified. Typically in the trade, the molecular weight range of the product is classified as low, medium, or high. The preferred range of molecular weight for purposes of this invention is that classified as medium.

Mixtures of polyesters with hydrocarbon oils are also effective plasticizers in the present invention. One objective of using such a mixture is to couple the high efficiency of the relatively high cost polyester with the low cost of the hydrocarbon oil. The cost and performance of a compound plasticized with such a mixture can be improved significantly for a given application because properties can be tailored more precisely, or filler levels can be increased.

When used alone, the amount of polyester plasticizer in the composition of the present invention is from about 1 to about 5% by weight, preferably from about 2 to about 5% by weight.

Where a mixture of the polyester plasticizer and a hydrocarbon processing oil is employed, the relative proportions of the two components can be varied over a wide range depending upon performance objectives. Mixtures of plasticizers containing 50% or less of the polyester are preferred for economic reasons, and most preferred are those containing 20% or less of the polyester.

Polyethers and polyether esters are also useful as plasticizers in blends of the ethylene copolymers and fillers described above. In general, polyether plasticizers are oligomers or low molecular weight polymers of alkylene oxides; polymers of ethylene or propylene oxide are the most common types available commercially. These polyethers can be prepared by ring opening polymerization of various cyclic ethers and by polymerization aldehydes, using various types of catalysts, or by acid or base catalyzed polymerization of an alkylene oxide by itself or by alkoxylation of a starting alcohol or the like. Polyethers can be terminated by hydroxyl groups to form the diol (glycol) or, in the case of adducts of alkylene oxides with glycerol, for example, the triol, and so forth. The hydroxyl-terminated polyether can also be reacted with an acid to form the ester. Fatty acids such as lauric and stearic acids are commonly used; the most common examples of these compounds are the mono- and diesters of polyethylene or polypropylene glycol. The molecular weight of polyethers may range up to those typical of high polymers.

Preferred polyether compositions in the practice of this invention are those consisting of the polyols based on random and/or block copolymers of ethylene oxides and propylene oxides. The copolymer polyols provide better performance in terms of efficiency in compounds of the present invention containing very high levels of filler.

When used alone the amount of polyether plasticizer in the composition of the present invention is from about 1 to about 5% by weight, preferably from about 2 to about 5% by weight.

Mixtures of the polyether or the polyether ester plasticizers with either a polyester plasticizer or a hydrocarbon processing oil can also be used in the practice of this invention. The advantage of a polyether/polyester combination is the lower cost since the polyethers are cheaper than the polyesters. Combinations of polyether and processing oil are also cheaper because of the lower cost of the oil.

The relative proportions of the two components in a combination of polyether and polyester can be adjusted according to the efficiency of the system based on property requirements and cost. Those based primarily on polyester will not be as stiff and will be more expensive, for example, than those based primarily on a polyether or polyether ester.

Where a mixture of the polyether or polyether ester and hydrocarbon oil is employed, the relative proportions used will again depend upon cost and property requirements. Since polyethers are more expensive than processing oils, plasticizer mixtures that contain 50% or less of the polyethers are preferred.

As referred to above, a mixture of processing oil, on the one hand, and epoxidized oil, polyester or polyether or polyether ester, or any combination thereof, on the other hand, can also be used as the plasticizer for the compositions of the present invention.

Where a mixture of plasticizers is used, the amount of plasticizer may range from about 1 to about 5% by weight, preferably from about 2 to about 5% by weight. Most preferably when using a filler of medium density, such as calcium carbonate, the amount of plasticizer is from about 2 to about 5% by weight, and when using a filler of higher density, such as barium sulfate, the amount of plasticizer is from about 1 to about 4% by weight.

Plasticizers comprising a processing oil are preferred.

Fillers

The third essential ingredient of the composition of the present invention is the filler, which modifies the density to affect sound deadening. The percentage of filler that can be included in the composition of the present invention on a weight basis is primarily a function of the density of the filler. Particle size and shape of the filler also will have an effect on properties of blends. Fine particle size fillers generally have a tendency to result in higher blend viscosities and they are also more expensive. No. 9 Whiting (about 95% through 325 mesh) represents a viable midpoint in coarseness, availability, and cost. More preferred fillers are calcium carbonate and barium sulfate, and most preferred is calcium carbonate. The amount of filler present in the composition of the present invention is from about 80 to about 90% by weight. Most preferably, when using a filler of medium density, such as calcium carbonate, the amount of filler is from about 80 to about 85% by weight, and when using a filler of higher density, such as barium sulfate, the amount of filler is from about 85 to about 90% by weight.

Organic Acids

The final essential ingredient for the compositions of this invention is an organic acid of the proper type. So-called “dimer” and “trimer” acids (dimers and trimers of simpler straight-chain forms) having from 36 to 60 carbon atoms are highly effective in enhancing elongation and in increasing melt index, particularly at the very high filler loadings of this invention. These dimer and trimer acids are derived from mono- or poly-unsaturated acids in which one or more of the olefinic bonds of a monomeric acid molecule reacts with one or more of the olefinic bonds of other monomeric acid molecules to form acyclic, cyclic, aromatic or polycyclic dimers and/or trimers. Typically a mixture of structures results, with cyclic addition products predominating. Of particular note are dimer acids (CAS Number 61788-89-4) and trimer acids (CAS Number 68937-90-6) derived from C₁₈ fatty acids such as linoleic acid. The unsaturated bonds remaining after dimerization or trimerization can be hydrogenated to provide fully saturated dimers (CAS Number 68783-41-5) or fully saturated trimers. Dimer and trimer acids can be obtained from Arizona Chemical Company, Panama City, Fla. under the Unidyme® tradename.

Mixtures of the above-mentioned acids can be employed in compositions of this invention. Of particular note is a mixture of dimer and trimer acids, as described above, containing at least 51% and typically 55% trimer acids (measured by gas chromatography) obtained from Arizona Chemical Company, Panama City, Fla. as Unidyme® 60.

Mono-, di- and trivalent metal salts of these organic acids, in particular the calcium and zinc salts, are also effective in carrying out the purposes of this invention.

In using organic acids of the types described in the compositions of this invention the amount is from about 0.05 to about 5% by weight, and preferably from about 0.1 to about 2%. Most preferably, the amount is from about 0.12% to about 0.65%.

Polymers, both homo- and copolymers, other than the ones referred to above, can also be used to some extent in combination with the above specified polymers without significantly interfering with the advantages obtained by the present invention. These include, but without limitation, polymers such as ethylene/carbon monoxide and ethylene/sulfur dioxide. Similarly other ingredients can also be added to the compositions of the present invention by a compounder in order to obtain some desired effect, such as reduction of cost, or enhancement of a physical property. Accordingly, extender resins, waxes, foaming agents, crosslinking agents, antioxidants, etc., that are widely used, particularly in hot melts, can be included in the compositions of the present invention. Illustrative examples of several special additives and of potentially desirable resin ingredients are given below.

The basic blends described above are essentially free of surface tack at ambient temperature. Even if made with a “bleeding” type of paraffinic oil, the final sheet, at ambient temperature, may be slippery to the touch but will not be tacky. (Of course, as temperatures are increased to the 200° F. to 250° F. level, the blends will be progressively softened and will adhere well to many substrates.) From time to time, compounders probably will want to produce sheeting with enhanced surface tack or adhesiveness. This can be done in the blends described in the present invention by incorporating a tackifier resin in the formulation. The tackifier may be any suitable tackifier known generally in the art such as those listed in U.S. Pat. No. 3,484,405. Such tackifiers include a variety of natural and synthetic resins and rosin materials. The resins that can be employed are liquid, semi-solid to solid, complex amorphous materials generally in the form of mixtures of organic compounds having no definite melting point and no tendency to crystallize. Such resins are insoluble in water and can be of vegetable or animal origin, or can be synthetic resins. The resins can provide substantial and improved tackiness of the composition. Suitable tackifiers include, but are not necessarily limited to the resins discussed below.

A class of resin components, which can be employed as the tackifier composition hereof, are the coumarone-indene resins, such as the para-coumarone-indene resins. Generally the coumarone-indene resins that can be employed have a molecular weight that ranges from about 500 to about 5,000. Examples of resins of this type that are available commercially include those materials marketed as “Picco”-25 and “Picco”-100.

Another class of resins that can be employed as tackifiers useful in this invention is the terpene resins, including also styrenated terpenes. These terpene resins can have a molecular weight range from about 600 to 6,000. Typical commercially available resins of this type are marketed as “Piccolyte” S-100, as “Staybelite Ester” #10, which is a glycerol ester of hydrogenated rosin, and as “Wingtack” 95, which is a polyterpene resin.

A third class of resins that can be employed as the tackifier are the butadiene-styrene resins having a molecular weight ranging from about 500 to about 5,000. A typical commercial product of this type is marketed as “Buton” 100, a liquid butadiene-styrene copolymer resin having a molecular weight of about 2,500. A fourth class of resins that can be employed as the tackifier in this invention are the polybutadiene resins having a molecular weight ranging from about 500 to about 5,000. A commercially available product of this type is that marketed as “Buton” 150, a liquid polybutadiene resin having a molecular weight of about 2,000 to about 2,500.

A fifth class of resins that can be employed as the tackifier are the so-called hydrocarbon resins produced by catalytic polymerization of selected fractions obtained in the refining of petroleum, and having a molecular weight range of about 500 to about 5,000. Examples of such resin are those marketed as “Piccopale”-100, and as “Amoco” and “Velsicol” resins. Similarly, polybutenes obtained from the polymerization of isobutylene may be included as a tackifier.

The tackifier may also include rosin materials, low molecular weight styrene hard resins such as the material marketed as “Piccolastic” A-75, disproportionated pentaerythritol esters, and copolymers of aromatic and aliphatic monomer systems of the type marketed as “Velsicol” WX-1232. The rosin that may be employed in the present invention may be gum, wood or tall oil rosin but preferably is tall oil rosin. Also the rosin material may be modified rosin such as dimerized rosin, hydrogenated rosin, disproportionated rosin, or esters of rosin. Esters can be prepared by esterifying the rosin with polyhydric alcohols containing from 2 to 6 alcohol groups.

A more comprehensive listing of tackifiers, which can be employed in this invention, is provided in the TAPPI CA Report #55, February 1975, pages 13-20, inclusive, a publication of the Technical Association of the Pulp and Paper Industry, Atlanta, Ga., which lists well over 200 commercially available tackifier resins.

In use, the compounder generally will want to select an ethylene-based copolymer and a tackifier resin that will be mutually compatible; chemical similarities that will indicate compatibility can be used for guidance. For a few highly specialized uses, such as super-hot-tack, quick-stick blends, the compounder may well elect to use incompatible systems. Finally, the reverse effect may be sought—in such instances, where an unusually slippery surface is desired, incorporation of small amounts of a slip aid such as Armid O may prove beneficial.

In using tackifier resins, the amount used in compositions of this invention is from 0 to about 5% by weight of the blend.

The teachings above have dealt with several different potential polymeric ingredients on an “individual-ingredient” basis to outline contributions possible from widely varying resin or polymer types. It must be stressed that polymer ingredients of the above types can, of course, be mixed so that, for example, the compounder may elect to modify a simple four-component composition (i.e. EVA/oil/filler/organic acid) by replacing part of the EVA with a small amount of tackifier for adhesivity. In addition, part of the oil can be replaced with a polyester or polyether-type additive to attain highly effective plasticization with a lower total amount of plasticizer. Thus, the possible combinations and permutations available to a skilled compounder will be infinite, yet remain within the spirit and intent of this invention.

The blends of the present invention are thermoplastic in nature and therefore can be recycled after processing. The recycled material may also contain textile fibers, jute, etc. present in the trim obtained during production of the finished product (e.g., back-coated automotive carpet).

Preferred are compositions of this invention wherein component (a) comprises two different ethylene/vinyl acetate copolymers; the plasticizer of component (b) is a processing oil; the filler of component (c) is CaCO₃; and the organic acid of component (d) is selected from the group consisting of dimer and trimer acids, and mixtures thereof.

Compositions of this invention may comprise other optional additives such as conventional additives used in polymeric materials including, for example, carbon black, which is used as a coloring agent or filler; titanium dioxide, which is used as a whitening agent or filler; other pigments; dyes; optical brighteners; surfactants; stabilizers such as antioxidants, ultraviolet ray absorbers, and hydrolytic stabilizers; anti-static agents; fire-retardants; lubricants; reinforcing agents such as glass fiber and flakes; antiblock agents; release agents; processing aids; and/or mixtures thereof.

A commercially sized batch-type Banbury or equivalent intensive mixer is suitable for preparing the compositions of the present invention. A Farrel continuous mixer (“FCM”) is also a suitable mixing device. In either instance, dry ingredients are charged in routine fashion. It is convenient in most cases to inject the plasticizer component directly into the mixing chamber of either unit as per widely used practice with this type of equipment. When more than one plasticizer is used, and where any one of the plasticizers is present in a small amount (less than about 10 weight percent of the total plasticizer mixture), the plasticizers should be blended before addition to the other ingredients used in the filled compositions. This will facilitate uniform distribution of each plasticizer component in the final composition and thus ensure that optimum properties are obtained. Similarly, since the amounts of organic acid employed generally are so small (less than 1% for many cases), it is important to be certain that the organic acid is thoroughly mixed into the final blend. If this is not done, highly erratic values for physical properties may result. Thus, it may often prove helpful to premix the organic acid into a portion of one of the other ingredients, e.g., a liquid organic acid may be premixed with the process oil or a solid organic acid may be premixed with an aliquot of the filler. If desired, the copolymer and the plasticizer(s) can be precompounded as a “masterbatch” in a suitable intensive mixing device (e.g., Banbury mixer or screw extruder). This “masterbatch” can then be compounded with the filler and the other remaining ingredients to produce the final composition. A mix cycle of about 3 minutes is generally adequate for the Banbury mixer at an operating temperature ranging typically from about 325° F. to about 375° F. The operating rate for the FCM unit generally will fall within ranges predicted by literature prepared by the Farrel Company, Ansonia, Conn. Here, temperatures ranging typically from about 325° F. to about 425° F. are effective. In both cases, a very low plasticizer level, for example about 1 to 3%, may require higher temperatures. While not evaluated, it is expected that other devices for handling viscous mixes (MI of 0.1 to 20) should be entirely satisfactory.

Generally, changes in the sequence of addition of ingredients have not been found to be significant, provided that the final mixture is thoroughly fluxed to attain homogeneity.

Once blends are mixed, routine commercial practices may be used, such as underwater melt cutting plus drying or use of sheeting plus chopping methods, to produce a final composition in pellet form. Alternately, the hot mixture also may be immediately fabricated into a final form, e.g. sheeting, molding, etc.

The highly-filled compositions described herein may be processed industrially into final sheet, film or three-dimensional solid form by using standard fabricating methods well known to those skilled in the art. Thus, fabricating methods such as extrusion, calendering, injection or rotomolding, extrusion coating, sheet laminating, sheet thermoforming, etc. are all practical means for forming the compositions of this invention.

Sheet articles are typically extruded in one step and often subjected to thermoforming, such as for example described in U.S. Pat. No. 4,386,187, which is incorporated herein in its entirety by reference. Film articles can be prepared by extrusion and thermoforming, or by casting.

The blends of the present invention can readily be extruded onto a substrate, such as automotive carpet, foam, fabric or scrim material, or can be extruded or calendered as unsupported film or sheet. Depending upon the equipment used, and the compounding techniques employed, it is possible to extrude a wide range of film thickness, from below 20 mils to above 100 mils. Accordingly, this provides industry with an opportunity to vary the amount of sound deadening to be attained by varying film thickness, density of blends, ratio of filler load to binder, and similar techniques well known in the art.

As sound management articles, the highly filled compositions are useful in sound dampening components for automotive and other applications. The level of filler that these blends can bind without unacceptable degradation of the physical properties is significantly higher than many other polymers, particularly at higher temperatures.

The compositions of the present invention, when employed in sound barrier layer applications, are often used in conjunction with a decoupling layer of foam or fibrous felt. The high density of the compositions of the present invention itself acts as a barrier to the transmission of sound vibrations. In addition, use of a decoupling layer (in conjunction with said high density barrier layer) prevents the direct transmission of sound vibrations from the substrate through the barrier layer (which would occur if the sound barrier layer were directly affixed to the substrate). The sound barrier layer usually has a density of between 1.5 and 2.6 g/cm³. The sound barrier composition of this invention can be calendered or extruded into a sheet prior to thermoforming to fit the contours of the vehicle, appliance or other structure to which it is applied. The barrier layer may then be laminated with the foam or fiber layer, and is often also layered with a carpet or other decorative layer. The substrate is the material of construction of the article for which sound management is required and typically comprises one or more materials selected from metal, plastic, glass, natural fibers, synthetic fibers, and wood.

Primary use for the compositions of the present invention will probably be in the sheeting field, particularly for low cost, dense, sound-deadening structures. Outstanding characteristics such as improved “hand”, “drape”, reduced stiffness, higher elongation and reduced thickness of the extruded sheeting result from the compositions of the present invention.

The filled thermoplastic compositions of this invention have many sound management uses including, but not limited to, extruded sheet to be used as a moldable sound barrier in sound deadening applications including transport systems such as automobiles, motorcycles, buses, tractors, trains, trams, airplanes, and the like. The sound-deadening sheet comprising a composition of this invention may be used in various ways:

When applied to automotive carpet, blends described are an effective and economic means to deaden sound, while also simultaneously serving as a moldable support for the carpet. The application of the compositions of the present invention in carpets, and particularly in automotive carpets, is essentially identical to methods already described in U.S. Pat. No. 4,191,798, the disclosure of which is hereby incorporated by reference.

When used in sheet form, especially when coated onto a fabric, the blends can be installed in other areas of an automobile, truck, bus, etc., such as side panels, door panels, roofing areas, headliners and dash insulators. The compositions of this invention may also be used in automotive door and truck liners, rear seat strainers, wheel well covers, carpet underlayments, dash mats, sound damped automotive enclosures such as oil pans, disc brake pads, mufflers, etc.

In sheet form, the highly filled blends may be used as drapes or hangings to shield or to surround a noisy piece of factory equipment such as a loom, a forging press, conveyor belts and material transfer systems, etc.

The compositions of this invention may be used for sound deadening in small and large appliances, including dishwashers, refrigerators, air conditioners, and the like; household items such as blender housings, power tools, vacuum cleaning machines, and the like; lawn and garden items such as leaf blowers, snow blowers, lawn mowers, and the like; small engines used in boating applications such as outboard motors, water-jet personal watercraft, and the like. Additional applications include devices for modifying the sound of a drum, loudspeaker systems, acoustically damped disc drive systems, and the like.

In construction and building industries, compositions of this invention may be used as wallpapers/coverings, composite sound walls, thermoformable acoustical mat compositions, vibration-damping constrained-layer constructions, and sound insulation moldable carpets. In laminated sheet form, the blends, faced with another material, can be used to achieve both a decorative and a functional use, such as dividing panels in an open-format office.

Preferred sound-deadening sheets and preferred carpets comprise the preferred compositions described above.

Other uses are possible. An advantage of the blends of this invention is that certain physical properties, such as flexibility and toughness, which are typically reduced when fillers are added to polymers, can be maintained within useful limits even with at the very high filler concentrations described herein. Thus, blends of this invention could be used in the manufacture of wire and cable components in a variety of electronic, telecommunications and similar areas, of various molded parts, of sealants and caulks, or in other uses where flexibility, toughness and heat resistance are desired, coupled with the economies normally achieved by the incorporation of low cost fillers.

The following Examples are presented to more fully demonstrate and further illustrate various aspects and features of the present invention. As such, the showings are intended to further illustrate the differences and advantages of the present invention but are not meant to be unduly limiting.

General Procedures for Examples:

The Examples that follow are given for the purpose of illustrating the present invention. All parts and percentages are by weight unless otherwise specified.

In all Examples, the ingredients were premixed in a one-gallon (about 3.8 Liter) can by shaking the contents manually for about 0.5 minutes. (Where liquid fatty acids are employed, it is often preferably to premix the very small amount of acid into the much larger volume of liquid plasticizer, separately, before adding the liquid to the one-gallon can, to ensure reaching homogeneity rapidly). The ingredients were then added to a Banbury-type laboratory-sized intensive high-shear mixer. Mix conditions used were fluxing for 3 minutes, at a temperature ranging from about 325° F. to about 375° F. (from about 160° C. to about 190° C.).

Testing Criteria for Examples:

Melt Index (MI) was measured in accord with ASTM D-1238, condition E, at 190° C., using a 2160-gram weight, with values of MI reported in grams/10 minutes. Density was determined in accord with ASTM D-792. DSC Melting point (m.p.) was determined in accord with ASTM D-3418. Vicat softening point was determined in accord with ASTM D-1525. Shore A hardness was determined in accord with ASTM D-2240. Ring and Ball softening point was determined in accord with ASTM E28-67(77).

Without further elaboration, it is believed that one skilled in the art using the preceding description can utilize the present invention to its fullest extent. The following Examples are, therefore, to be construed as merely illustrative, and not limiting of the disclosure in any way whatsoever.

### EXAMPLES AND COMPARATIVE EXAMPLES

Materials Used

EVA-1: Ethylene/18% vinyl acetate copolymer having MI of 0.07, density of 0.940 g/cm³, and Ring and Ball softening point of 223° C.

EVA-2: Ethylene/28% vinyl acetate copolymer having MI of 6, density of 0.955 g/cm³, and Vicat softening point of 46° C.

Stearic Acid (octadecanoic acid), a monocarboxylic acid, CH₃(CH₂)₁₆—COOH, molecular weight of 284.49, density 0.94 g/cm³, melting point of 70° C., commercial grade available under the trade name Industrene® B from Crompton Corporation.

Dimer/Trimer Acid Blend, as described above, containing at least 51% and typically 55% trimer acids (measured by gas chromatography) available from Arizona Chemical Company, Panama City, Fla. as Unidyme® 60.

H3000 oil, a naphthenic processing oil having SUS Viscosity at 210° F. of 128 (Saybolt Universal Seconds), Flash Point of 510° F., Initial Boiling Point of 830° F. and Ford Fog Value of 80%, available from Ergon.

BLK CON, carbon black dispersed in polyethylene, used as a colorant, available under the tradename Polyone® 2447.

CaCO₃, filler, molecular weight of 100.9, density 2.93 g/cm³, decomposition temperature of about 825° C., commercial grade.

Example 1 is a blend of this invention. Comparative Example C1 is a commercial grade of a blend filled with 79% CaCO₃ (the highest filler level available commercially), using stearic acid as the acid component. Comparative Example C2 is an experimental blend filled with 82% CaCO₃, using stearic acid as the acid component. Values in Table 1 are in weight % of the components in the blends.

TABLE 1

| | | Comparative | Comparative |
|---|---|---|---|
| Component (wt. %) | Example 1 | Example C1 | Example C2 |
| EVA-1 | 8.0 | 7 | 8.0 |
| EVA-2 | 4.5 | 6.3 | 4.5 |
| Stearic Acid | 0 | 0.35 | 0.4 |
| Dimer/Trimer Acid | 0.4 | 0 | 0 |
| Blend | | | |
| H3000 oil | 4.7 | 7.0 | 4.7 |
| BLK CON | 0.4 | 0.4 | 0.4 |
| CaCO₃ | 82 | 79 | 82 |

Table 2 summarizes the mechanical properties of the blends of Table 1.

TABLE 2

| | | | |
|---|---|---|---|
| Property | Ex. 1 | Comp. Ex. C1 | Comp. Ex. C2 |

| | | | |
|---|---|---|---|
| Mean break elonga- | 410 | 450 | 176 |
| tion (%) | | | |
| Mean U.T. strength | 219 | 200 | 171 |
| (%) | | | |
| Yield strength (psi) | 200 | — | 170 |
| DSC m. p. (° C.) | 82.95 | — | 80.49 |
| Melt index | 0.57 | 5 | 0.77 |
| Shore A hardness | 90 | — | 95 |
| Flex modulus (psi) | 26198 | — | 34312 |

Inspection of the properties summarized in Table 2 for Comparative Example C1, with 79 weight % of CaCO₃ and using stearic acid as the organic acid component, shows that this blend exhibits good elongation and strength. In comparison, Comparative Example C2, with 82 weight % of CaCO₃ and using stearic acid as the organic acid component, has inadequate elongation to break and strength properties. Thus, increasing filler loads above 79%, using a fatty acid as the organic acid component, does not provide properties that are suitable for processing into the sound-deadening articles described herein.

The properties of Example 1, a blend of this invention, show that the use of a dimer/trimer acid blend in place of a fatty acid as the organic acid component provides excellent elongation, good flexibility and good strength for such a highly filled composition.

Having thus described and exemplified the invention with a certain degree of particularity, it should be appreciated that the following claims are not to be so limited but are to be afforded a scope commensurate with the wording of each element of the claim and equivalents thereof.

1. A filled thermoplastic composition consisting essentially of
(a) from about 1 to about 15% by weight of at least one ethylene/vinyl ester copolymer;
(b) from about 1 to 5 percent by weight of at least one plasticizer selected from the group consisting of processing oils, epoxidized oils, polyesters, polyethers, and polyether esters;
(c) from about 80 to about 90% by weight of filler;
(d) from about 0.05 to about 5% by weight of at least one organic acid or acid derivative selected from the group consisting of dimer and trimer acids having from 36 to 60 carbon atoms, and mixtures thereof; and optionally
(e) from 0 to about 5% by weight of tackifier,
wherein all weight percents are based on the total weight of components (a) through (e).

2. The composition of claim 1 wherein said vinyl ester is vinyl acetate.

3. The composition of claim 2 wherein component (a) comprises two different ethylene/vinyl acetate copolymers.

4. The composition of claim 1 wherein said plasticizer comprises a processing oil.

5. The composition of claim 1 wherein component (a) comprises two different ethylene/vinyl acetate copolymers; the plasticizer of component (c) is a processing oil; the filler of component (d) is CaCO₃; and the organic acid of component (d) is selected from the group consisting of dimer and trimer acids, and mixtures thereof.

6. A sound-deadening sheet comprising a composition of claim 1.

7. A carpet having a backside coating comprising a composition of claim 1.
